(19) United States
(12) Patent Application Publication
(10) Pub. No.: US 2010/0283227 A1
(43) Pub. Date: Nov. 11, 2010

(54) SERVICE CART

(75) Inventors: Thomas Perelli, Winchester, VA (US); Matthew S. Kepner, Cross Junction, VA (US); Grant Mason, Stephens City, VA (US)

Correspondence Address: MOORE & VAN ALLEN PLLC, P.O. BOX 13706, Research Triangle Park, NC, 27709, US

(73) Assignee: Rubbermaid Commercial Products, LLC, Winchester, VA (US)

(21) Appl. No.: 12/730,038

(22) Filed: Mar. 23, 2010

Related U.S. Application Data
(63) Continuation of application No. 61/162,530, filed on Mar. 23, 2009.

(51) Int. Cl. B62B 3/02

(52) U.S. Cl. 280/639

(57) ABSTRACT

A cart comprising a first support structure supported on wheels. A second support structure is connected to the first support structure. The second support structure is movable relative to the first support structure between a first extended position and a second retracted position. A collapsible container is supported by the second support structure. The container occupyies a first extended position when the second support structure is in the first position and a second collapsed position when the second support structure is in the retracted position.

This application claims benefit of priority under 35 U.S.C. §119(e) to the filing date of to U.S. Provisional Application No. 61/162, 530 as filed on Mar. 23, 2009, which is incorporated herein by reference in its entirety.

### BACKGROUND OF THE INVENTION

Carts are often used in older and smaller buildings throughout the world having relatively small and narrow hallways and rooms. Moreover, these carts may be used by relatively small stature people. This architecture and user demographic, respectively, creates common problems for a user such as a housekeeper or custodian. Small carts that may be more maneuverable in confined spaces lack sufficient capacity. These smaller carts may get piled up with linens or other articles resulting in obstructed visibility, a lack of stability because of the higher center of gravity and the creation of an “eye sore” in a public environment. Older, smaller and some newer buildings may have small and/or cluttered closets not allowing for tidy and easy storage of larger carts or multiple smaller carts.

### SUMMARY OF THE INVENTION

A cart comprises a first support structure supported on wheels. A second support structure is connected to the first support structure. The second support structure is movable relative to the first support structure between a first extended position and a second retracted position. A collapsible container is supported by the first and second support structures. The container occupies a first extended position when the second support structure is in the first position and a second collapsed position when the second support structure is in the retracted position.

The second support structure may slide in a track formed on the first support structure. Antifriction devices may be located between the second support structure and the track. The antifriction devices may comprise rollers that rotate as the second support structure is slid into and out of the track. The second support structure may comprise a base that is received in the track where a first pair of rollers is provided on the top of the base and a second pair of rollers is provided on the bottom of the base. The first support structure may be supported on a plurality of wheels. The second support structure may be supported on at least one wheel. The collapsible container may be provided with rigid inserts. The first support structure may be connected to the second support structure by a folding assembly. The folding assembly may comprise a first linkage connected between the first support structure and the second support structure. The first linkage may comprise a first link pivotably connected to the first support structure and a second link pivotably connected to the second support structure where the first link and second link are pivotably connected to one another such that the first link and the second link pivot inward toward the second support structure. The first link may be longer than the second link. A support member may extend between and be connected to the first linkage and the second linkage. A locking mechanism may fix the first link and the second link in position. The first link and the second link may occupy an over-center locking configuration when the second support structure is in the first extended position. The collapsible container may be supported by the first support structure and the second support structure. The collapsible container may be supported only by the second support structure. A fabric top having an aperture may cover the collapsible container. The folding assembly may comprise a first linkage having one end connected to the first support structure at a moving pivot and the opposite end connected to the second support structure at a second moving pivot, and a second linkage having one end connected to the first support structure at a third moving pivot and the opposite end connected to the second support structure at a fourth moving pivot, where the first linkage and the second linkage are connected to one another at their midpoints at a pivot.

### BRIEF DESCRIPTION OF THE DRAWINGS

FIG. 1 is a perspective view of one embodiment of the cart.

FIG. 2A is a bottom perspective view of the cart of FIG. 1.

FIG. 2B is a partially exploded bottom perspective view of the cart of FIG. 1.

FIG. 3 is a detailed exploded view of the linkage used in the folding mechanism.

FIGS. 4A-4C are perspective views showing the folding and unfolding of a collapsible container in a cart.

FIG. 5 is a schematic bottom perspective view of a locking mechanism.

FIGS. 6 through 8 are perspective views showing the sequence of expanding and collapsing the cart of FIG. 1.

FIGS. 9-12 are side views showing various alternate embodiments of the cart of FIG. 1.

FIGS. 13 and 14 are perspective views of another embodiment of the cart.

FIG. 15 is perspective views of still another embodiment of the cart.

FIG. 16 is a perspective view of yet another embodiment of the cart.

FIGS. 17 and 18 are top views of the cart of FIG. 18.

FIG. 19 is a partial section perspective view showing a locking mechanism on the cart of FIG. 1.

FIG. 20 is a more detailed section view showing the locking mechanism of FIG. 19.

FIG. 21 is a perspective bottom view showing the locking mechanism of FIG. 19.

### DETAILED DESCRIPTION OF EMBODIMENTS OF THE INVENTION

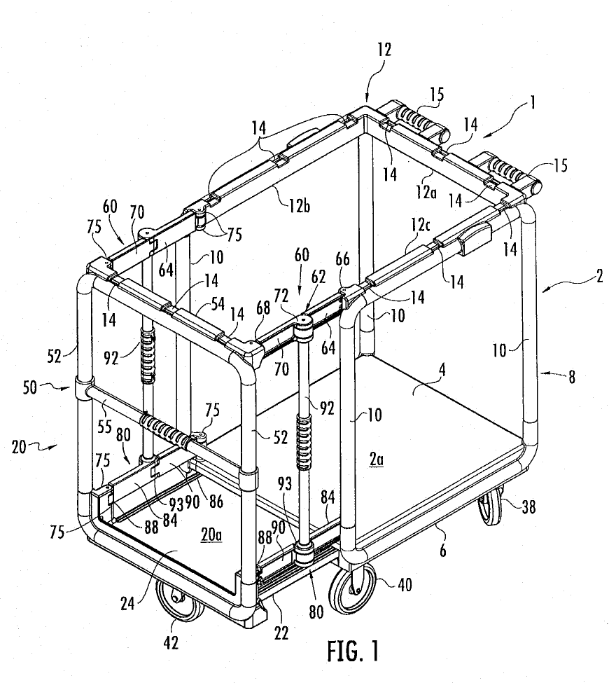

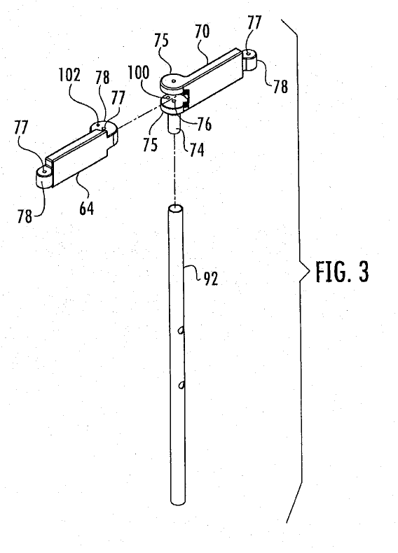

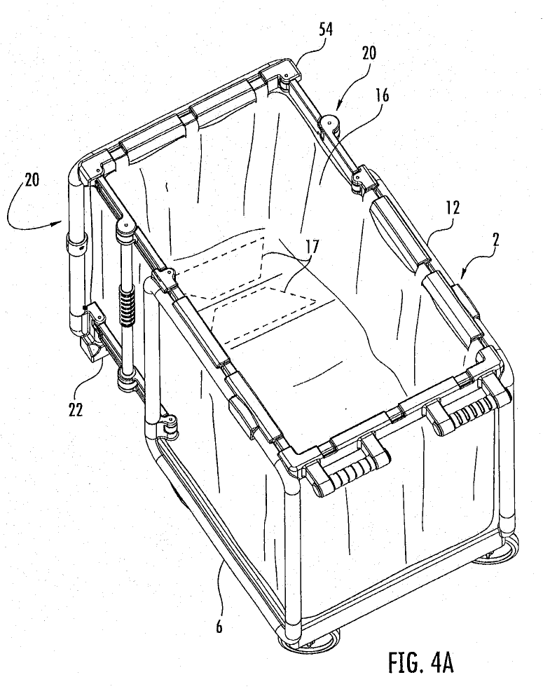

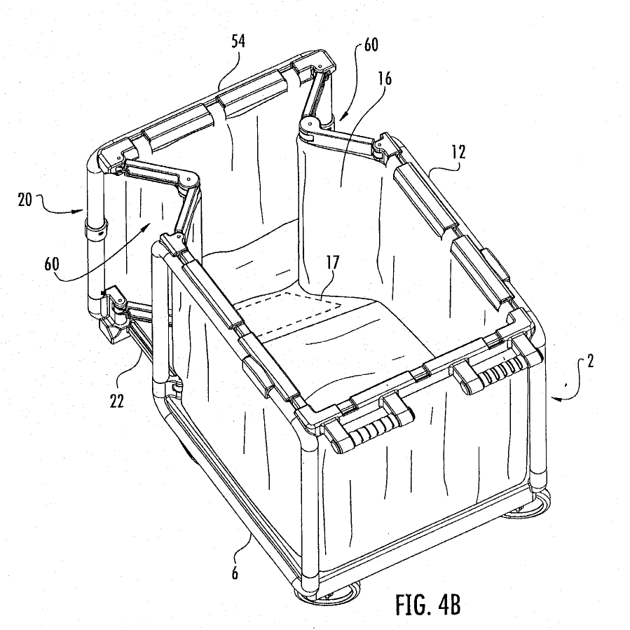

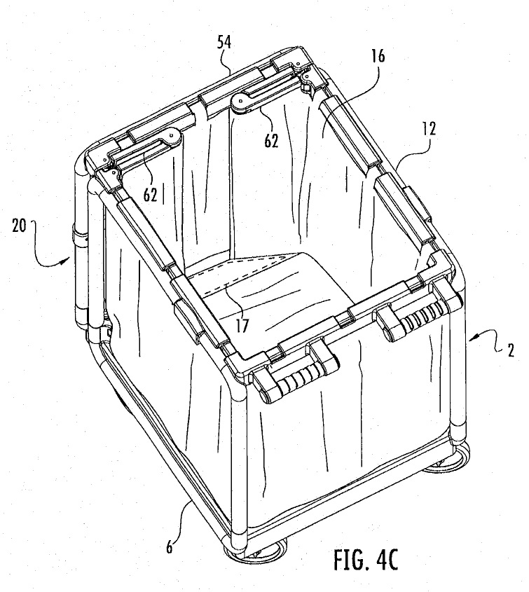

Referring to FIGS. 1 through 3, a first embodiment of the cart is shown generally at 1 comprising a first support structure 2 comprising a base 6 and a platform 4. A superstructure 8 is supported on the base 6. In the illustrated embodiment the superstructure 8 comprises a plurality of uprights 10 that support a horizontal frame 12. The frame 12 is shown as a U-shaped member having three sides 12a, 12b and 12c and an open fourth side. The frame 12 is provided with a plurality of hooks, snaps, clamps or other connectors 14 that support the upper open end of a flexible bag or container 16 (FIGS. 4a-4c), such as a textile bag, such that the user can place articles, such as linens, in the bag. The frame 12 may also be formed with handles 15 for the user to grip during movement of the cart. While in the illustrated embodiment the base 6 and superstructure 8 are designed to support a bag 16, the first support structure 2 may comprise shelves, cabinets, drawers, specialty tool or equipment holders or the like that may be used to hold a wide variety of tools, equipment or goods.

A second support structure 20 is supported for movement relative to the first support structure 2. The second support structure 20 comprises a base 22 and platform 24. Support structure 20 moves transversely relative to the first support structure 2 in a telescoping manner such that the support structure 20 may move from a first extended position to a second retracted position. The support structure 2 defines a first storage area 2a and support structure 20 defines a second collapsible storage area 20a.

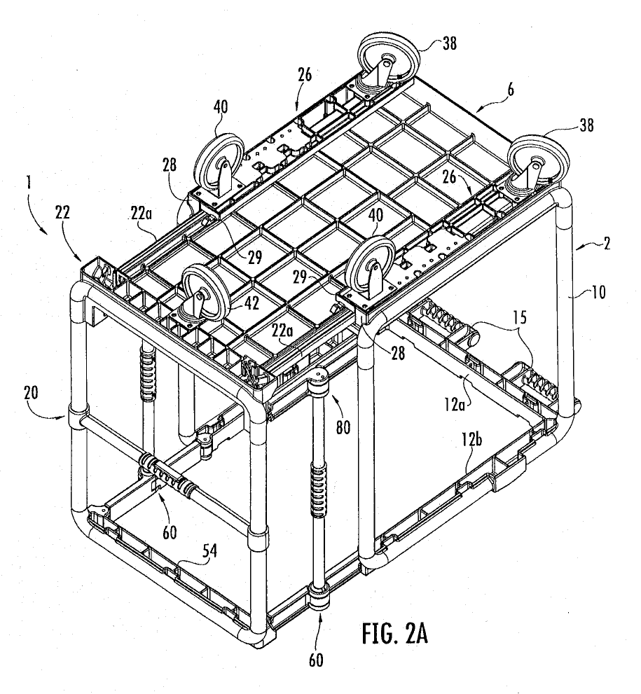

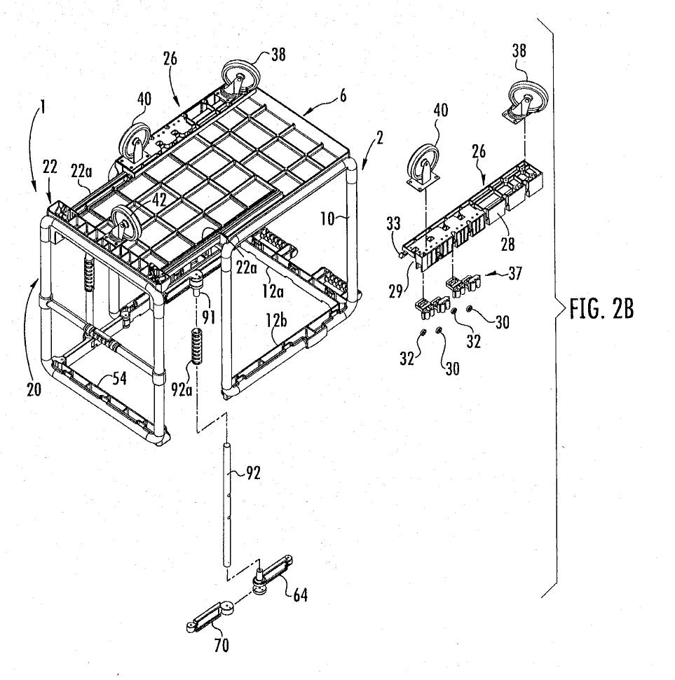

Referring to FIGS. 2A and 2B the bottom of base 6 is provided with at least one track that supports the base 22 and allows the base 22 to move relative to base 6. In the illustrated embodiment the bottom of base 6 comprises two tracks 26 that are spaced from one another and are dimensioned to receive the longitudinal edges 22a of the base 22 in a sliding manner. The tracks 26 are created by housings 28 that are secured to the bottom of the base 6 such that a longitudinal channel 29 is created between the bottom of the base 6 and each housing 28. The ends of the channels 29 are open to allow the base 22 to be slidably inserted into the channels. To facilitate the movement of base 22 along the tracks 26 antifriction devices are provided. In the illustrated embodiment the antifriction devices comprise rollers that rotate as the base 22 is slid into and out of the tracks 26. A first pair of rollers 30 contacts the top surface of base 22. A second pair of rollers 32 contacts the bottom surface of base 22. Rollers 30 and 32 may be retained in holders 37 attached to housings 28. As a result, the rollers 30 and 32 are in rolling contact with base 22 such that the base 22 can be easily moved relative to the base 6. Two pairs of rollers are used to support each longitudinal edge 22a of the base. While two rollers are shown on the top and bottom of base 22 a fewer or greater number of rollers may be used. Further, the rollers may be mounted on base 22. The rollers may be replaced by other low friction mechanisms such as bearings, low coefficient of friction surfaces or the like. The housings 28 and the base 6 may also be formed as a one-piece member and the housings 28 may extend over a greater or lesser portion of base 22.

The base 6 is supported on a plurality of wheels such that it may be easily maneuvered over a surface by the user. In the illustrated embodiment four wheels are used although a greater or fewer number of wheels may be used provided that the cart is stably supported. In the illustrated embodiment two of the wheels 38 are swivel wheels or casters that can rotate about a vertical axis such that the cart may be easily turned. The other two wheels 40 may be “fixed” wheels that are able to roll but are otherwise fixed with the axis of rotation perpendicular to the direction of travel of the cart.

Base 22 is also proved with a wheel for supporting the distal end of the second support structure 20 remote from support structure 2. In the illustrated embodiment one such caster wheel 42 is used that is centrally located along the width of the support structure 20. Additional wheels may be used. Further, wheel 42 may be eliminated if the wheels 38 and 40 adequately support the cart when the second support structure 20 is both the extended and retracted positions.

Referring to FIGS. 1 through 3, the second support structure 20 also includes a superstructure 50 that includes a plurality of uprights 52 that support a horizontal frame 54 and a crossbar 55. The frame 54 is provided with a plurality of hooks, snaps, clamps or other connectors 14 that support the upper open end of a flexible bag 16, such as a textile bag. In the illustrated embodiment two uprights 52 are provided supporting frame 54 that extends along the front of the base 22 such that the frame 54 is disposed perpendicular to the direction of movement of the second support structure 20 relative to the first support structure 2. When the second support structure 20 is moved to the collapsed or retracted position, the superstructure 50 extends across the open side of frame 12.

Referring to FIGS. 4A-4C a collapsible bag or container 16 may be supported in the spaces 2a and 20a, identified in FIG. 1, defined by support structure 2 and support structure 20, respectively. The collapsible bag 16 may be provided with rigid inserts 17. Specifically, sections of the bag, both floor and side walls, are folded and unfolded by the closing and opening of the cart. The bag's side walls, during the transition between opening and closing, correspond to the changing geometry of the folding assemblies 60. The bag side walls match the folding assemblies' geometry in parallel at all positions providing retracting with a minimal footprint. Efficient folding of the bag's floor uses rigid inserts 17 fixed to the floor's textile material. Each insert 17 may be trapezoidal shaped to neatly fold the floor of the bag with the least amount of resistance and to avoid hitting the folding assemblies as they fold inward. This provides a neat flat vertical fold in the closed position. Additionally, the rigid inserts facilitate the neat vertical fold allowing the bag's floor to only fold upward.

Referring to FIGS. 1, 2B and 3, a folding assembly 60 connects the second support structure 20 to the first support structure 2. One folding assembly 60 is provided on each side of the cart. Folding assembly 60 comprises a first upper linkage 62 connected between the first superstructure 8 and second superstructure 50. In the illustrated embodiment the upper linkage 62 is shown positioned at the top of the first and second superstructures. The first upper linkage 62 comprises a first link 64 pivotably connected to the superstructure 8 of the first support structure 2 at hinge 66 and a second link 70 pivotably connected to the superstructure 50 of the second support structure 2 at hinge 68. The hinges 66 and 68 allow the links 64 and 70 to pivot about vertical axes such that the links 64 and 70 may swing inward toward the interior space of the second support structure 20. The first link 64 and second link 70 are pivoted to one another at hinge 72 that includes a downwardly extending post 74 that connects to vertical support 92.

The second lower linkage 80 is substantially the same as the first upper linkage 60 except that the post extends upwardly to connect to vertical support 92. Linkage 80 comprises a first link 84 pivotably connected to the superstructure 8 of the first support structure 2 at hinge 86 and a second link 90 pivotably connected to the superstructure 50 of the second support structure 20 at hinge 88. The hinges 86 and 88 allow the links 84 and 90 to pivot about vertical axes such that the links may swing inward toward the interior of the second support structure 20. The first link 84 and second link 90 are pivoted to one another at hinge 92 that includes an upwardly extending pin 91 that connects to support 92.

In the illustrated embodiments the hinges are formed of a pair of spaced, opposed members 75 each having a coaxial pivot pin 76 extending therefrom. A knuckle 78 fits between the opposed members 75 and has coaxial aligned holes 77 that receive the pins 76 such that the members may rotate relative to one another about the axis defined by pins 76.

The upper linkage 60 and lower linkage 80 are arranged with the hinges disposed vertically in-line with one another. Support member 92 extends between the downwardly extending post of linkage 60 and the upwardly extending post of linkage 80 to add rigidity to the system and to coordinate the movement of the upper and lower linkages. To coordinate the movement of the upper linkage 60 and lower linkage 80 and collapse the cart the user may push on support members 92 to cause the linkages to fold inwardly simultaneously.

The user may also pull on cross member 55 to extend the cart from the collapsed position. When the second support structure 20 is in the extended position shown in FIG. 1 the upper linkage 60 and frame 54 provide support for the hanging flexible container such that the open top end of the container is supported.

To maintain the linkages in the extended position shown in FIG. 1 a locking mechanism may be provided. In the illustrated embodiment the locking mechanism comprises a projection 100 formed on one of the knuckle 78 or members 75 that engages a mating recess 102 formed on the other of the knuckle or plates. The engagement of the projections with the recesses fixes the linkages 60 and 80 in the extended position. A second projection and recess may be formed on the knuckle 78 and/or members 75 to lock the linkages 60 and 80 in the collapsed position. The engagement of the projections with the recesses may be overcome by the user to force the links between the collapsed and extended positions. Other locking mechanisms may be used such as magnets, a separate latch or the like. Further, the links may be locked in the extended position using an over-center arrangement. In such an arrangement the links are moved from the collapsed position to the extended position of FIG. 1 where the links 64, 70 and 84, 90 move slightly beyond a straight line “on center” position. With the links in an over-center locking configuration, the links can only be folded by an inward force applied to the hinges 72 and 93. The over-center arrangement may be used in conjunction with the separate locking mechanism.

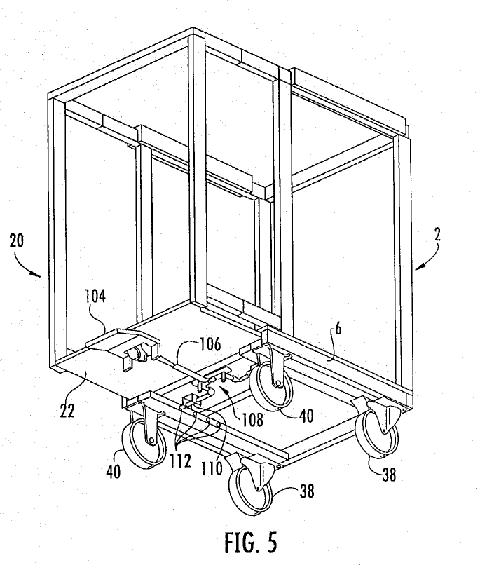

An alternate locking mechanism is shown in FIG. 5 where a foot pedal 104 is pivotably connected to the bottom of one of the support structures. In the illustrated embodiment the pedal 104 is connected to the base 22 of the second support structure 20 although it may also be connected to the base 6 of support structure 2. The foot pedal 104 is connected by a rod 106 to a linkage 108 such that when the pedal 104 is depressed the rod 106 is moved to activate the linkage 108 and retract pins 110 from engagement with mating holes 112 formed in the base 6. After the pins 110 are retracted the support structure 20 may be moved relative to support structure 2 to adjust the size of the cart. The mating holes 112 may be located such that the support structure 20 is locked in position at the fully open and/or fully retracted positions. Additional holes may be used to lock the support structure 20 at any intermediate position relative to the support structure 2.

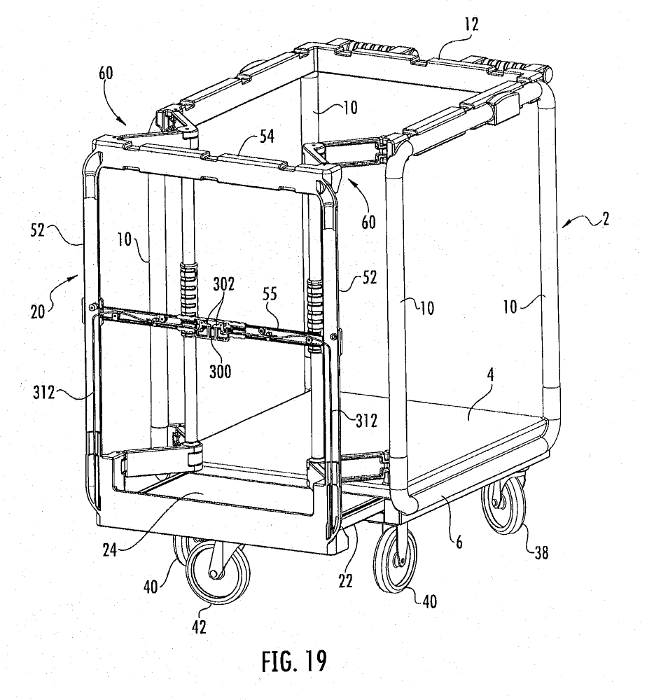

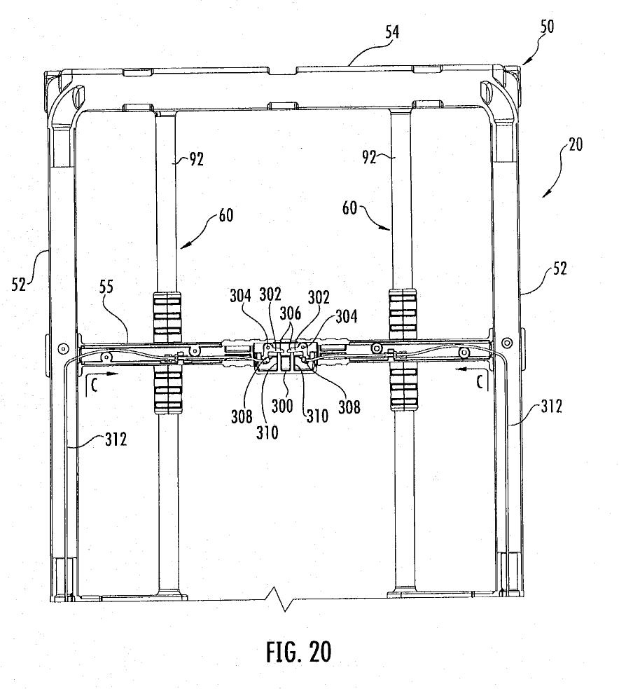

An alternate locking mechanism is shown in FIGS. 19, 20, and 21 that may be used to lock the cart in the collapsed position. The locking mechanism comprises a trigger handle 300 that is movably supported on cross bar 55 of support structure 20. In one embodiment the trigger handle moves between an extended locked position and a depressed unlocked position. The trigger handle is biased to the unlocked position such as by a spring. Two levers 302 are pivotably mounted to cross bar 55 at a pivot pins 304. Each lever 302 has a first end 306 arranged at a substantially right angle relative to a second end 308 where the first end 306 is disposed opposite a camming surface 310 formed on the trigger handle 300. When the trigger handle 300 is depressed camming surfaces 310 are forced into engagement with the first ends 306 of levers 302 causing the levers to rotate such that the second ends 308 of the levers 302 are moved toward one another. The second ends 308 of the levers 302 are connected to cables 312. When trigger handle 300 is depressed and levers 302 are rotated, the cables 312 are pulled in the direction of arrows C.

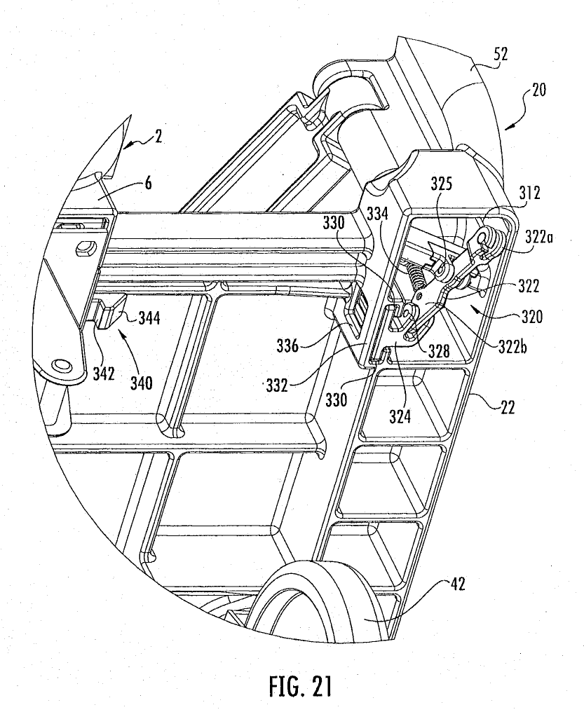

The opposite ends of cables 312 are connected to latch assemblies 320 located at the front corner of support structure 20 adjacent to and below base 22 as shown in FIG. 21. FIG. 21 shows one such latch assembly 320. A second latch assembly 320 is located at the opposite front corner of base 22. The latch assembly comprises a link 322 pivoted at pivot pin 325 at a mid point thereof. One end 322a of the link 322 is connected to cable 312 and the opposite end 322b of link 322 is connected to latch 324 at pivot pin 328. When cable 312 is pulled in the direction of arrow C by trigger handle 300 end 322a of link 322 is raised causing link 322 to pivot about pivot pin 325 to lower end 322b. As end 322b is lowered, latch 324 is pulled downward to a release or unlocked position. Latch 324 is guided by channels 330 such that it is limited to sliding movement relative to wall 332 of base 22. A spring 334 biases the latch 324 to the raised, locked position when the trigger handle 300 is released. An opening 336 is formed in wall 332 such that the latch 324 moves between the locked and unlocked positions behind opening 336.

Base 6 of support structure 2 comprises a mating strike member 340 that extends from the base 6 such that it is disposed opposite to opening 336 and extends into opening 336 when the support structure 20 is in the collapsed position. Strike member 340 comprises an extending finger having a catch 342 formed on one side thereof and a camming surface 344 formed at the end thereof. When the support structure 20 is moved to the collapsed position the strike member 340 enters hole 336 and camming surface 344 strikes latch 324 forcing latch 324 downward to the unlocked position. As the strike member 340 fully enters opening 336 catch 342 becomes aligned with the latch 324 such that the spring 334 moves the latch upward into engagement with catch 342. The engagement of latch 324 with catch 342 locks the support structure 20 in the collapsed position relative to support structure 2.

To release the lock, trigger handle 300 is depressed causing levers 302 to pivot and pull cables 312. Each cable 312 pulls on end 322a of lever 322 of its associated latch assembly 320 causing end 322b of lever 322 to pull latch 324 to the unlocked or release position where latch 324 is no longer in interfering engagement with catch 342. The support structure 20 can then be pulled away from support structure 2.

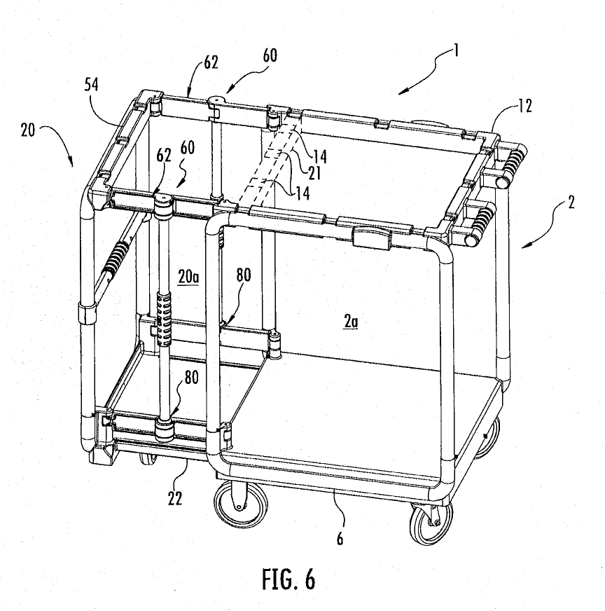

The cable release system described with respect to FIGS. 19, 20 and 21 may be used with the locking device of FIG. 6. Specifically, linkage 108 may be activated by the described cable system rather than, or in addition to, the foot pedal 104.

Operation of the cart of the invention will be explained with reference to FIGS. 4A through 4C and 6 through 8. FIGS. 6 and 4A show the cart with the second support structure 20 in the extended position where the base 22 is extended from the base 6. In this position the linkages 62 and 80 of linkage assemblies 60 are in the extended positions with linkages 62 extending from and forming an extension of frame 12. Frame 54 also forms an extension of linkages 62 such that frame 12, frame 54 and linkages 60 are substantially the same horizontal plane. A flexible container 16 may be supported by support structure 2 and/or support structure 20 in its expanded configuration as shown in FIG. 4A by connecting straps or other mechanisms on the container 16 to connectors 14.

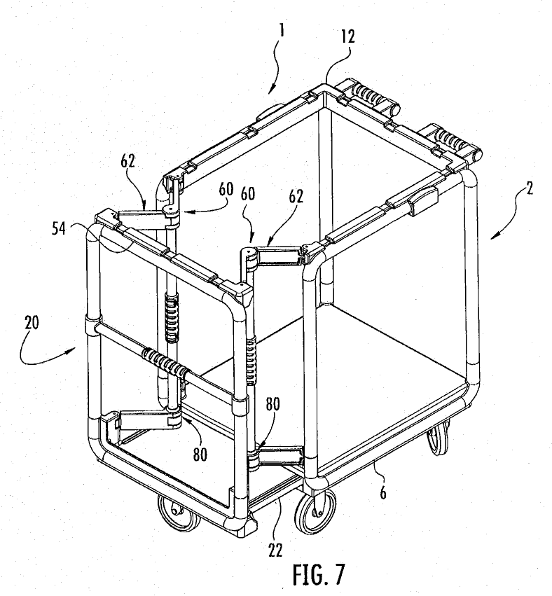

Referring to FIG. 7, the cart is illustrated in the partially closed position where the second support structure 20 is moved toward the first support structure 2. In this position base 22 is partially pushed into the base 6 and the linkages 62 and 80 or folding assemblies 60 are partially folded. The linkages 62 and 80 fold such that the links pivot toward the interior of the cart. A flexible bag 16 supported by support structures 2 and 20 also folds inward on itself as the second support structure is moved toward the retracted position as shown in FIG. 4B.

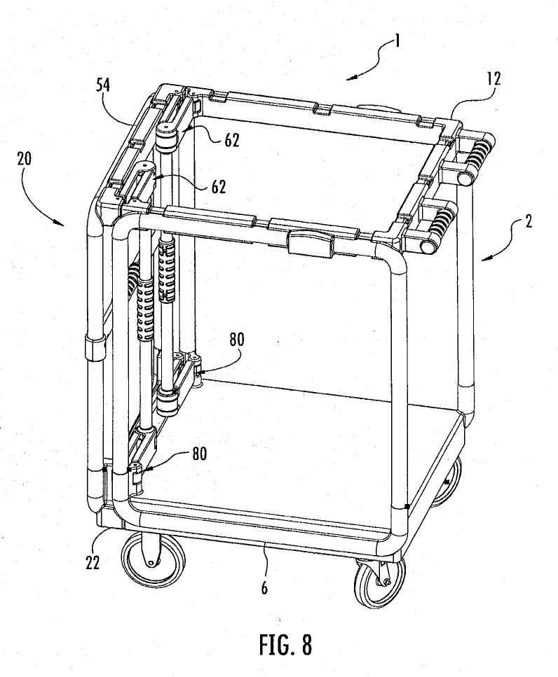

Referring to FIG. 8, the cart is illustrated in the completely collapsed position where the second support structure 20 is moved completely toward the first support structure 2. In this position base 22 is fully pushed into the base 6 and the folding assemblies 60 are fully folded. The linkages 62 and 80 fold such that the links pivot toward the interior of the cart and are disposed parallel to the frame 54. Linkages 62 and frame 54 close the open end of frame 12. The flexible bag also folds inward on itself as the second support structure is moved toward the retracted position to the completely retracted position as shown in FIG. 4C. The foot print of the cart is collapsed from the largest extent shown in FIG. 6 to its smallest extent shown in FIG. 8.

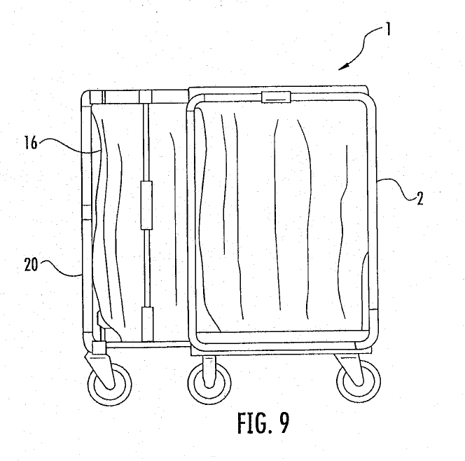

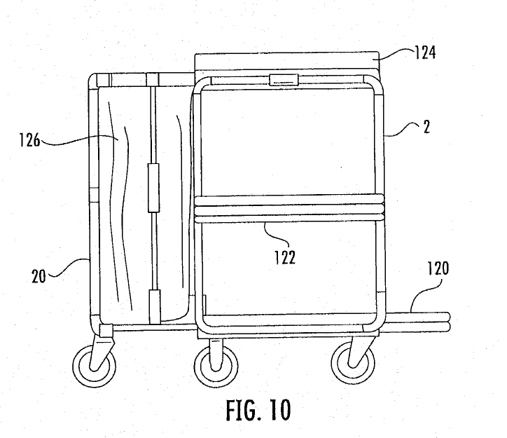

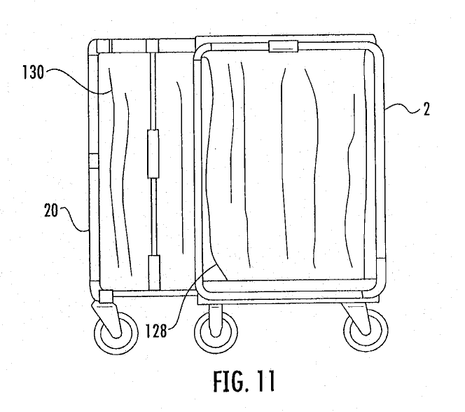

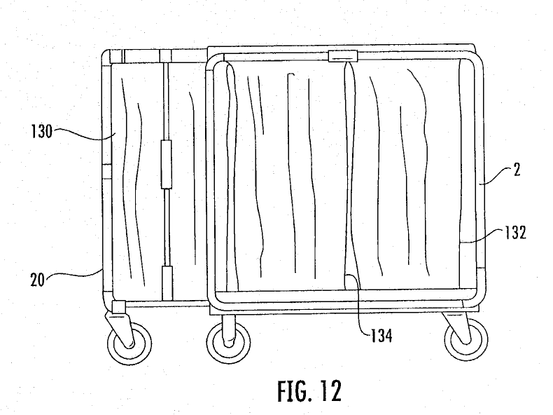

FIG. 9 shows one embodiment of the cart where a single flexible bag 16 is suspended by both the first support structure 2 and the second support structure 22 such that when the cart is in the expanded configuration shown in FIGS. 6 and 4C a single open bag fills both spaces 20a and 2a. Such an arrangement may be used for bulk collection, such as bulk linen collection. When the cart is moved to the retracted position of FIGS. 4C and 8 the flexible bag 16 is folded on itself. FIG. 10 shows another embodiment of the cart where the first support structure 2 is formed with storage units such as shelves or platforms 120, 122 and 124 and the flexible bag 126 fills only the space 20a defined by the second support structure 20. When the support structure 20 is collapsed the bag 126 is also collapsed. Such an arrangement may be used for janitorial or maintenance functions. FIG. 11 shows another embodiment of the cart where the first support structure 2 supports a first flexible bag 128 and the second support structure 20 supports a second smaller bag 130. When the cart is collapsed the second bag 130 is collapsed in space 20a but the first bag 128 remains open in space 2a. FIG. 12 shows another embodiment of the cart similar to that of FIG. 11 except that the first support structure 2 supports a first flexible bag 132 and a second flexible bag 134 and the second support structure 20 supports a second smaller bag 130. When the cart is collapsed the second bag 130 is collapsed in space 20a but the bags 132 and 134 remain open in space 2a. Such arrangements may be used for separating articles such as linens or recycling. When a smaller container is supported only in the space 20a defined by support structure 20 a separate beam 21 may be used that extends across the open side of frame 12 and that supports the side of the collapsible container that faces the support structure 2 as shown in phantom line in FIG. 6.

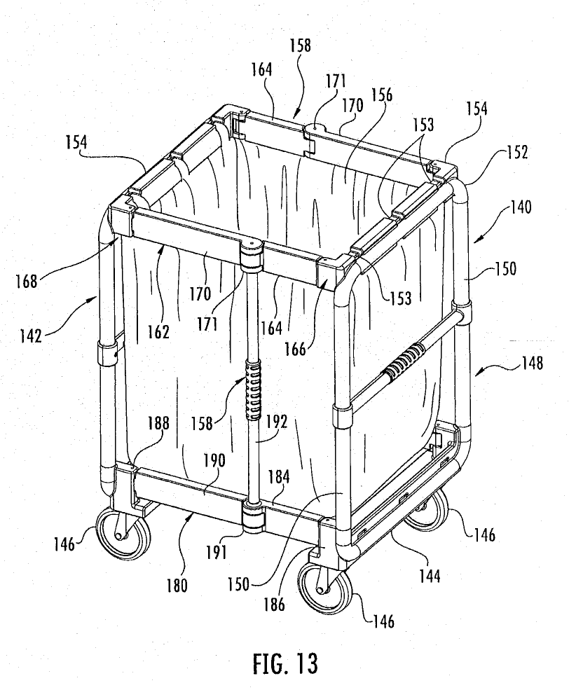

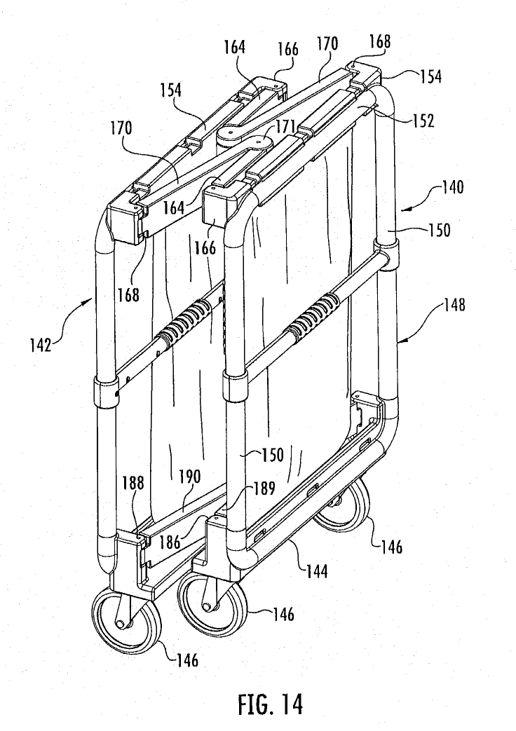

Referring to FIG. 13, another embodiment of a collapsible cart is shown comprising a first support structure 140 and a second support structure 142. The support structures are identical such that specific reference will be made to support structure 140. Support structure 140 comprises a base 144 comprising a relatively narrow elongated rigid member supported at each end by a swivel wheel 146. A superstructure 148 is mounted on the base 144 and comprises a pair of uprights 150 one mounted near each end of the base 144. The uprights 150 are joined at their upper ends by a cross bar 152. The cross bar 152 supports a frame 154 that includes a plurality of connectors 153 for supporting the upper open end of a collapsible bag 156. A folding assembly 158 joins each side of the support structure 140 to the support structure 142 such that the support structures can collapse toward one another from the extended position of FIG. 13 to the collapsed position of FIG. 14. Specific reference will be made only to one folding assembly it being understood that the other folding assembly is identical. Folding assembly 158 comprises a first upper linkage 162 connected at or near the top of the first and second superstructures. The first upper linkage 162 comprises a first link 164 pivotably connected to the superstructure of the first support structure 140 at hinge 166 and a second link 170 pivotably connected to the superstructure of the second support structure 142 at hinge 168. Link 164 is connected to link 170 at hinge 171. The hinges 166 and 168 allow the links 164 and 170 to pivot about a vertical axis such that the links may swing inward toward the interior of the second support structure.

The second lower linkage 180 comprises a first link 184 pivotably connected to the superstructure of the first support structure 140 at hinge 186 and a second link 190 pivotably connected to the superstructure of the second support structure at hinge 188. Link 184 is connected to link 190 at hinge 191. The hinges 186 and 188 allow the links 184 and 190 to pivot about a vertical axis such that the links may swing inward toward the interior of the second support structure. The hinges may be formed as previously described with respect to the embodiment of FIG. 1.

The upper and lower linkages are arranged with the hinges disposed vertically in-line with one another. A support member 192 extends between the upper and lower linkages to add rigidity to the system and to coordinate the movement of the upper and lower linkages as previously described with respect to FIG. 1. When the folding assemblies 158 are in the extended position shown in FIG. 13 the upper linkages 162 and frames 154 provide support for the hanging flexible bag 156 such that the end of the top, open end of the bag is supported. Locking devices may be provided to lock the folding assemblies in position as previously described.

The folding mechanisms described with respect to FIGS. 13 through 16 are substantially the same as the folding mechanisms previously described with respect to FIGS. 1 through 3 except that the linkages in the embodiment of FIGS. 13 through 16 are asymmetrical. Specifically, links 164 and 184 are shorter than links 170 and 190 such that the hinges between the links are offset from the center of the linkage. The linkage on the opposite side of the cart is offset in the opposite direction. The offset in the center hinges makes the asymmetrical fold shown in FIG. 14. As a result, the casters 146 are clear of one another when the cart is in the collapsed configuration such that the casters 146 are free to rotate and roll and the cart can be easily rolled on the casters even in the collapsed configuration as shown in FIG. 14.

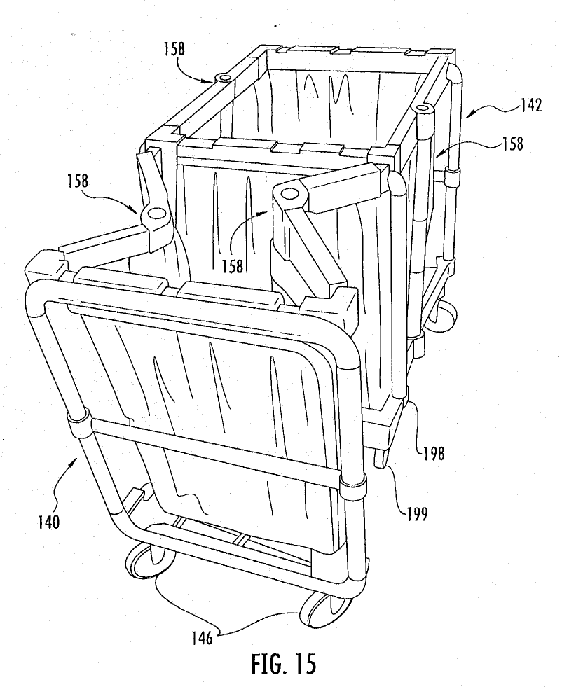

The embodiment of the invention shown in FIG. 15 is a modification of the cart shown in FIGS. 13 and 14. The cart comprises a center support structure 198 supported on wheels 199 and connected on one side to a first support structure 140 by folding assemblies 158, 160 and connected on the opposite side to a second support structure 142 by a second pair of folding assemblies 158, 160. The folding assemblies are provided with the offset center hinge such that the asymmetrical fold previously described with respect to FIGS. 13 and 14 also operates in this embodiment such that the casters 146 are clear of one another when the cart is in the collapsed configuration.

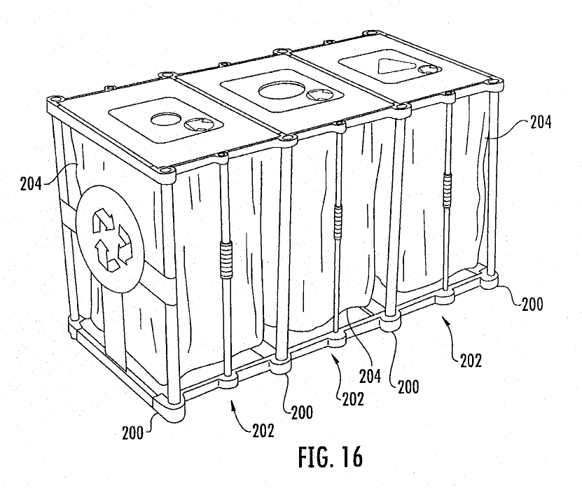

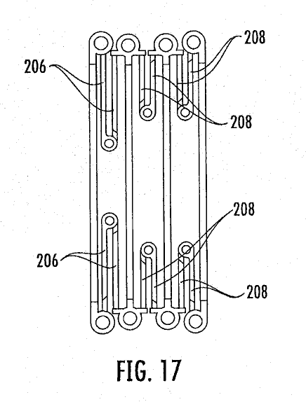

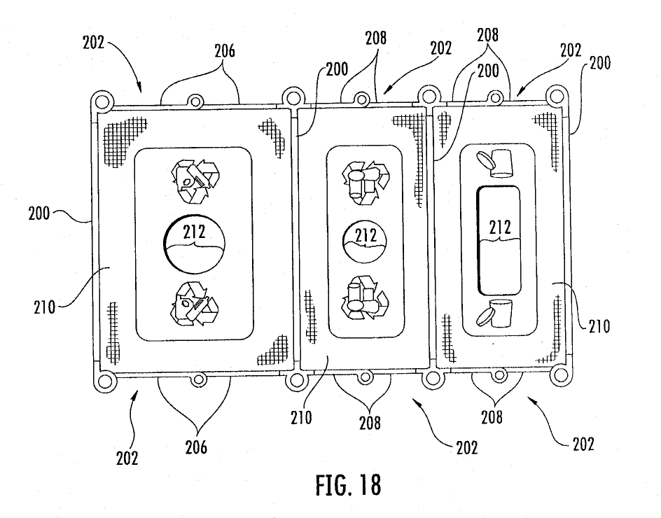

Referring to FIGS. 16 through 18 an alternate embodiment is shown comprising a plurality of support structures 200 connected by a plurality of folding assemblies 202 where folding assemblies 202 are substantially the same as the folding assemblies in the cart shown in FIGS. 1 through 3. A collapsible bag 204 is supported between each of the support structures 200. The folding assemblies 202 are symmetrical, rather than being asymmetrical as previously described with respect to FIGS. 13 through 15. By varying the length of the linkages the size of the area between the support structures 202 may be varied. Referring to FIGS. 17 and 18, the links 206 of the first area are longer than the links 208 of the other two areas such that the first area is larger than the second area and third area. Additionally, fabric tops 210 are provided over the areas between the support structures 200 such that the contents of the bags 204 are hidden from view. Apertures 212 may be provided in tops 210 to allow access to the bags. Such a system is suitable for use as collection devices such as trash or recycling centers in public areas. The sides of the cart may also be covered with fabric to hide the sides of the bags if desired. The support structures in the embodiment of FIGS. 16 through 18 may not include wheels such that they are relatively stationary structures.

The cart may be used for, yet is not limited to, the transport of clean and soiled linens for the hospitality and healthcare industries. The cart may also be used in other applications where a variable capacity cart may be desired such as material handling, maintenance, janitorial services or the like. Specifically, the cart can be pulled or pushed by a single person such as a housekeeper, custodian or other user. In one embodiment, the cart is properly sized for maneuverability down a hallway and/or to fit in a guest room or closet.

The cart may use one or more bulk capacity flexible containers, such as textile bags, to help reduce the cart's overall weight, lower cost and simplify the cart's size transformation. The size transformation enhances the usability to the customer/end user.

The end user grasps the left and right supports 92 with their left and right hands respectively and pushes in at the same time to initiate the collapse of the support structure 20 and collapsible container. Then the user simply pushes on the back end of support structure 20 to fold and close the container and reduce the size of the cart. To increase the size of the cart, the user may grasp a centrally located grip handle 55 on the back end of support structure 20. The grip handle 55 may have a button built into it to un-lock the closed position. The user pulls support structure 20 away from support structure 2. At this point that user can grab the two side supports 92 to fully open the cart and lock the linkages 60 and 80.

The collapsible cart provides the benefits of two different size carts where a single cart can be easily set to two sizes. This transformation between the two sizes enables a user to selectively increase the capacity of the cart when needed without the need to own and store a larger cart. The expansion to a larger cart also helps to maintain a lower center of gravity such that the cart is less likely to tip and also hides more of the load from public view. The ability to collapse to a smaller size reduces the larger size footprint for easier storage and provides easier maneuverability when transporting a smaller load.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A cart comprising:
a first support structure supported on a wheel;
a second support structure connected to the first support structure, said second support structure movable relative to the first support structure between a first extended position and a second retracted position;
a collapsible container supported by said first and second support structure, said container occupying a first extended position when said second support structure is in said first position and a second collapsed position when said second support structure is in said retracted position.

2. The cart of claim 1 wherein said second support structure slides in a track formed on said first support structure.

3. The cart of claim 1 wherein antifriction devices are located between said second support structure and said track.

4. The cart of claim 1 wherein the antifriction devices comprise rollers that rotate as the second support structure is slid into and out of the track.

5. The cart of claim 2 wherein said second support structure comprises a base that is received in said track, and a first pair of rollers is provided on the top of said base and a second pair of rollers is provided on the bottom of said base.

6. The cart of claim 1 wherein the first support structure is supported on a plurality of wheels.

7. The cart of claim 1 wherein said second support structure is supported on at least one wheel.

8. The cart of claim 1 wherein the collapsible container is provided with rigid inserts.

9. The cart of claim 1 wherein said first support structure is connected to said second support structure by a folding assembly.

10. The cart of claim 9 wherein said folding assembly comprises a first linkage connected between the first support structure and said second support structure.

11. The cart of claim 10 wherein the first linkage comprises a first link pivotably connected to the first support structure and a second link pivotably connected to the second support structure, the first link and second link being pivotably connected to one another such that the first link and the second link pivot inward toward the second support structure.

12. The cart of claim 10 wherein said folding assembly comprises a second linkage, a support member extends between and is connected to the first linkage and the second linkage.

13. The cart of claim 11 further including a locking mechanism that fixes the first support structure relative to the second support structure.

14. The cart of claim 11 wherein the first link and the second link are in an over-center locking configuration when the second support structure is in the first extended position.

15. The cart of claim 1 wherein said collapsible container is supported by said first support structure and said second support structure.

16. The cart of claim 1 wherein said collapsible container is supported only by said second support structure.

17. The cart of claim 11 wherein said first link is longer than said second link.

18. The cart of claim 1 wherein a fabric top having an aperture covers the collapsible container.

19. The cart of claim 9 wherein the folding assembly comprises a first linkage having one end connected to the first support structure at a moving pivot and the opposite end connected to the second support structure at a second moving pivot, and a second linkage having one end connected to the first support structure at a third moving pivot and the opposite end connected to the second support structure at a fourth moving pivot, said first linkage and said second linkage being connected to one another at their midpoints at a pivot.

20. A cart comprising:
a first support structure supported on at least one wheel and defining a first interior space;
a second support structure defining a second interior space, said second support structure connected to the first support structure by a linkage such that said second support structure is movable relative to the first support structure between a first extended position and a second retracted position;
a collapsible container supported in said first space, said container occupying a first extended position when said second support structure is in said first position and a second collapsed position when said second support structure is in said retracted position.
